(19) United States
(12) Patent Application Publication
(10) Pub. No.: US 2021/0063358 A1
(43) Pub. Date: Mar. 4, 2021

(54) ULTRASONIC SENSOR

(71) Applicant: KABUSHIKI KAISHA TOSHIBA, Minato-ku (JP)

(72) Inventors: Tomio ONO, Yokohama (JP); Yasuharu Hosono, Kawasaki (JP); Mitsunaga Saito, Inzai (JP)

(73) Assignee: KABUSHIKI KAISHA TOSHIBA, Minato-ku (JP)

(21) Appl. No.: 16/815,078

(22) Filed: Mar. 11, 2020

(30) Foreign Application Priority Data
Aug. 28, 2019 (JP) 2019-155963

(51) Int. Cl. G01N 29/44; G01N 29/22

(52) U.S. Cl. CPC G01N 29/44; G01N 2291/106; G01N 29/22

(57) ABSTRACT

According to one embodiment, an ultrasonic sensor includes first and second elements. The first elements emit a first ultrasonic wave. A first operation is performed. The first operation includes processing based on a first signal. The first signal corresponds to a first reflected wave of the first ultrasonic wave and is obtained from N_{R} of the second elements (N_{R} being an integer of 3 or more) included in the second elements. The first elements are arranged in a first direction at a first pitch p_{T}. The first pitch p_{T} is in the first direction. The N_{R} second elements are arranged at a pitch of the second elements. A component in the first direction of the pitch of the second elements is a second pitch p_{R}. p_{R}/p_{T} is not less than 0.97 times and not more than 1.03 times (N_{R}+j)/N_{R}. j is not n·N_{R}/m.

### CROSS-REFERENCE TO RELATED APPLICATIONS

This application is based upon and claims the benefit of priority from Japanese Patent Application No. 2019-155963, filed on Aug. 28, 2019; the entire contents of which are incorporated herein by reference.

### FIELD

Embodiments described herein relate generally to an ultrasonic sensor.

### BACKGROUND

There is an ultrasonic sensor using an ultrasonic wave. It is desirable for the ultrasonic sensor to have a wide detection region.

### BRIEF DESCRIPTION OF THE DRAWINGS

FIG. 1 is a schematic plan view illustrating an ultrasonic sensor according to a first embodiment;

FIG. 2A to FIG. 2C are graphs illustrating characteristics of an ultrasonic sensor;

FIG. 3A to FIG. 3C are graphs illustrating characteristics of the ultrasonic sensor according to the embodiment;

FIG. 4 is a graph illustrating characteristics of the ultrasonic sensor;

FIG. 5 illustrates characteristics of the ultrasonic sensor;

FIG. 6 illustrates characteristics of the ultrasonic sensor;

FIG. 7 illustrates characteristics of the ultrasonic sensor;

FIG. 8A and FIG. 8B are schematic views illustrating characteristics of an ultrasonic sensor according to a second embodiment;

FIG. 9A and FIG. 9B are graphs illustrating characteristics of the ultrasonic sensor according to the second embodiment;

FIG. 10 is a schematic plan view illustrating an ultrasonic sensor according to a third embodiment;

FIG. 11A and FIG. 11B are graphs illustrating characteristics of the ultrasonic sensor according to the third embodiment;

FIG. 12A and FIG. 12B are schematic cross-sectional views illustrating the ultrasonic sensor according to the embodiment;

FIG. 13 is a schematic view showing a usage example of the ultrasonic sensor according to the embodiment; and

FIG. 14 is a schematic view showing a usage example of the ultrasonic sensor according to the embodiment.

### DETAILED DESCRIPTION

According to one embodiment, an ultrasonic sensor includes a plurality of first elements, and a plurality of second elements. The first elements emit a first ultrasonic wave. A first operation is performed. The first operation includes processing based on a first signal. The first signal corresponds to a first reflected wave of the first ultrasonic wave and is obtained from N_{R} of the second elements (N_{R} being an integer of 3 or more) included in the plurality of second elements. The first elements are arranged in a first direction at a first pitch p_{T}. The first pitch p_{T} is in the first direction. The NA second elements are arranged at a pitch of the plurality of second elements. A component in the first direction of the pitch of the plurality of second elements is a second pitch p_{R}. p_{R}/p_{T} is not less than 0.97 times and not more than 1.03 times (N_{R}+j)/N_{R}. j is not n·N_{R}/m. m is an integer not less than 1 and not more than k. n is an integer not more than (m−1). j is an integer not less than 1 and not more than (N_{R}−1). k is an integer not less than 2 and not more than 6.

According to one embodiment, an ultrasonic sensor includes a plurality of first elements, and a plurality of second elements. The first elements emit a first ultrasonic wave. A first operation is performed. The first operation includes processing based on a first signal. The first signal corresponds to a first reflected wave of the first ultrasonic wave and is obtained from N_{R} of the second elements (N_{R} being an integer of 3 or more) included in the plurality of second elements. The first elements are arranged in a first direction at a first pitch p_{T}. The first pitch p_{T} is in the first direction. The N_{R} second elements are arranged at a pitch of the plurality of second elements. A component in the first direction of the pitch of the plurality of second elements is a second pitch p_{R}. N_{R}, the first pitch p_{T}, and the second pitch p_{R} satisfy

p_{R}/p_{T}=(N_{R}+j)/N_{R} (1), and

j≠n·N_{R}/m (2).

m is an integer not less than 1 and not more than k. n is an integer not less than 1 and not more than (m−1). j is an integer not less than 1 and not more than (N_{R}−1). k is an integer not less than 2 and not more than 6.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

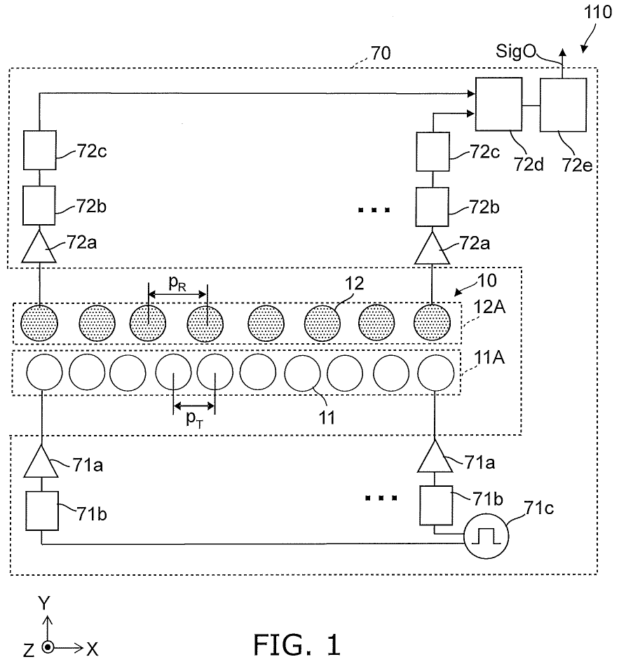

FIG. 1 is a schematic plan view illustrating an ultrasonic sensor according to a first embodiment.

As shown in FIG. 1, the ultrasonic sensor 110 according to the embodiment includes multiple first elements 11 and multiple second elements 12. The multiple first elements 11 are included in a first element array 11A. The multiple second elements 12 are included in a second element array 12A. The first element array 11A and the second element array 12A are included in an element part 10.

The multiple first elements 11 are arranged in a first direction at a first pitch p_{T} which is in the first direction. The first direction is taken as an X-axis direction. One direction perpendicular to the X-axis direction is taken as a Z-axis direction. A direction perpendicular to the X-axis direction and the Z-axis direction is taken as a Y-axis direction. For example, the multiple second elements 12 are arranged at the pitch of the multiple second elements 12. The component in the first direction (the X-axis direction) of the pitch of the multiple second elements 12 is a second pitch p_{R}. In the example shown in FIG. 1, the multiple second elements 12 are arranged along the first direction (the X-axis direction). In such a case, the second pitch p_{R} which is the pitch of the multiple second elements 12 is a length along the first direction (the X-axis direction).

In the embodiment, the direction in which the multiple second elements 12 are arranged may be oblique to the first direction. In such a case, the pitch (the first-direction component) of the multiple second elements 12 corresponds to the second pitch p_{R} when the direction in which the multiple second elements 12 are arranged is projected along the first direction. To simplify the description hereinbelow, the direction in which the multiple second elements 12 are arranged is taken to be the first direction. The direction in which the multiple second elements 12 are arranged is substantially parallel to the direction in which the multiple first elements 11 are arranged.

In the example, the ultrasonic sensor 110 includes a processor 70. In one example, the processor 70 includes a signal source 71c, multiple delay circuits 71b, multiple drive amplifiers 71a, multiple preamplifiers 72a, multiple A/D converters 72b, multiple delay circuits 72c, an adder circuit 72d, a detection circuit 72e, etc.

One of the multiple drive amplifiers 71a is electrically connected to one of the multiple first elements 11. One of the multiple delay circuits 71b is electrically connected to one of the multiple drive amplifiers 71a. The multiple delay circuits 71b is electrically connected to the signal source 71c.

One of the multiple preamplifiers 72a is electrically connected to one of the multiple second elements 12. One of the multiple A/D converters 72b is electrically connected to one of the multiple preamplifiers 72a. One of the multiple delay circuits 72c is electrically connected to one of the multiple A/D converters 72b. The multiple delay circuits 72c are electrically connected to the adder circuit 72d. The adder circuit 72d is electrically connected to the detection circuit 72e.

For example, a signal is output from the signal source 71c. The signal is supplied to the multiple first elements 11 via the delay circuit 71b and the drive amplifier 71a. An ultrasonic wave (e.g., a first ultrasonic wave) is emitted from the multiple first elements 11.

The emitted first ultrasonic wave is reflected by an object. The object is to be detected by the ultrasonic sensor 110. A reflected wave (a first reflected wave) that is obtained due to the reflection is incident on the multiple second elements 12. A signal (a received signal) that corresponds to the first reflected wave is obtained by the multiple second elements 12. For example, for each of the multiple second elements 12, the obtained received signal is supplied to the adder circuit 72d via the preamplifier 72a, the A/D converter 72b, and the delay circuit 72c. The output of the adder circuit 72d is supplied to the detection circuit 72e. An output signal SigO that corresponds to the detection result is obtained from the detection circuit 72e. The detection result includes, for example, the envelope characteristic of the received signal.

The multiple first elements 11 are, for example, transmitting elements. The multiple first elements 11 are, for example, ultrasonic transducers for transmitting. The multiple second elements 12 are, for example, receiving elements. The multiple second elements 12 are, for example, ultrasonic transducers for receiving.

The following first operation is performed by the ultrasonic sensor 110. For example, the first operation is performed by the processor 70. In the first operation, the multiple first elements 11 emit the first ultrasonic wave. In the first operation, processing is performed based on a first signal obtained from N_{R} second elements 12 (N_{R} being an integer of 3 or more) included in the multiple second elements 12. The first signal corresponds to the first reflected wave of the first ultrasonic wave. As described below, another operation may be performed in the embodiment. In the other operation, processing is performed based on the signal obtained from a different number of second elements 12. In the first operation, the detection processing is performed based on the first signal obtained from the N_{R} second elements 12.

For example, in the first operation, the processor 70 causes the first ultrasonic wave to be emitted from the multiple first elements 11. In the first operation, the processor 70 is capable of acquiring the first signal from the multiple second elements 12 and outputting a first operation signal as the output signal SigO (referring to FIG. 1). The first operation signal includes the result of the processing based on the first signal.

As described above, the multiple first elements 11 are arranged in the first direction (the X-axis direction) at the first pitch p_{T} which is in the first direction. The N_{R} second elements 12 are arranged at the pitch of the multiple second elements 12. The first-direction component of the pitch of the multiple second elements 12 is the second pitch p_{R}.

m is taken to be an integer not less than 1 and not more than k. n is taken to be an integer not less than 1 and not more than (m−1). j is taken to be an integer not less than 1 and not more than (N_{R}−1). Practically, for example, k is an integer not less than 2 and not more than 6. In the embodiment, the number N_{R}, the first pitch p_{T}, and the second pitch p_{R} satisfy the relationships

p_{R}/p_{T}=(N_{R}+j)/N_{R} (1), and

j≠n·N_{R}/m (2).

Practically, for example, p_{R}/p_{T} may be not less than 0.97 times and not more than 1.03 times (N_{R}+j)/N_{R}. In such a case as well, j is not n·N_{R}/m.

A large detection range is obtained thereby. For example, a wide field of view is obtained.

An example of characteristics of the ultrasonic sensor will now be described.

An array that includes multiple transmitting elements and multiple receiving elements is, for example, a phased array. In the range of an acoustical far-field, a directivity D of the phased array is given by the product of an array factor AF and an element factor EF (referring to Formula (3)). The array factor AF is determined by an element pitch p and a number N of elements. The element factor EF is determined by the configuration (e.g., a diameter ϕ) of the element.

D(θ)=AF(θ)·EF(θ) (3)

The angle θ is the zenith angle. The angle θ is an angle in the X-Z plane and is an angle referenced to the Z-axis direction. For example, the angle θ is 0 in a direction perpendicular to the multiple transmitting elements and the multiple receiving elements.

Using an array factor AF_{T} of the transmitting element array, a directivity D_{T} of the transmission is given by

D_{T}=AF_{T}·EF.

Using an array factor AF_{R} of the receiving element array, a directivity D_{R} of the reception is given by

D_{R}=AF_{R}·EF.

A directivity D_{TR} of the transmission and reception is given by the following Formula (4).

$$\begin{matrix}{D}_{T R} = {D}_{T} \cdot {D}_{R} \\ = ( A {F}_{T} \cdot EF ) \cdot ( {AF}_{R} \cdot EF ) \\ = ( {AF}_{T} \cdot {AF}_{R} ) \cdot ( {EF}^{2} ) \\ = A {F}_{T R} \cdot {EF}_{T R}\end{matrix} \qquad ( 4 )$$

“AF_{TR}” is the array factor of the transmission and reception. “EF_{TR}” is the element factor of the transmission and reception.

For example, the number of the multiple transmitting elements is taken as a number N_{T}; and the number of the multiple receiving elements is taken as a number N_{R}. The pitch of the multiple transmitting elements is taken as a pitch p_{T}; and the pitch of the multiple receiving elements is taken as a pitch p_{R}.

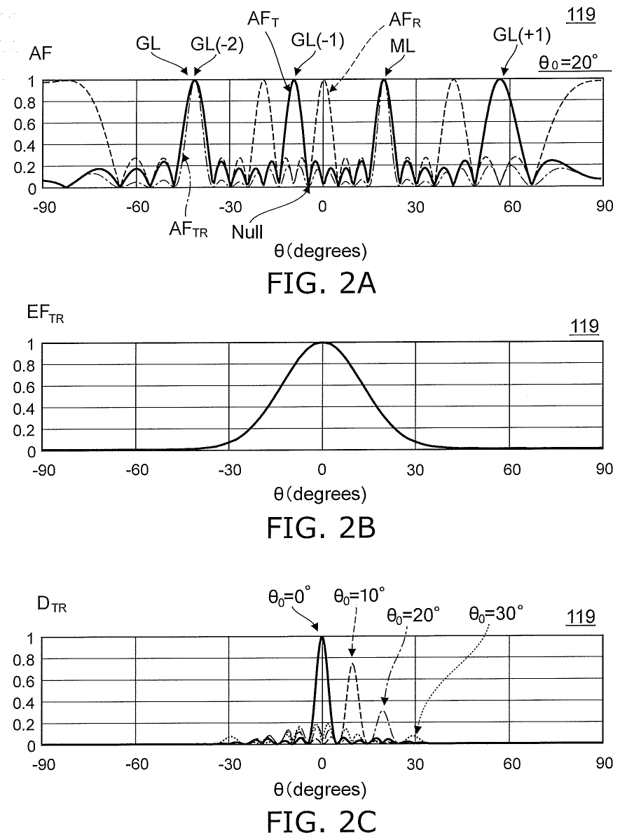

FIG. 2A to FIG. 2C are graphs illustrating characteristics of an ultrasonic sensor.

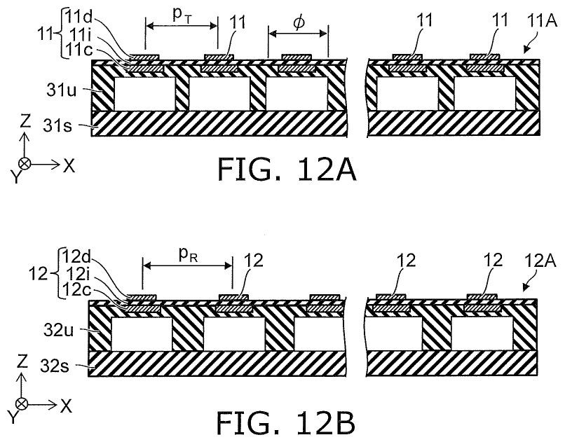

These drawings illustrate characteristics of an ultrasonic sensor 119 of the reference example. In the ultrasonic sensor 119, the number N_{T} is 6. The number N_{R} is 4. The pitch p_{T} is 2λ. The pitch p_{R} is 3λ. λ is the wavelength of the ultrasonic wave. The element pitch ratio (=p_{R}/p_{T}) is 3/2. The diameters ϕ of the transmitting elements and the receiving elements (e.g., referring to FIG. 12A) are 1.9λ. A frequency f of the ultrasonic wave is 40 kHz. In such a case, the wavelength λ is about 8.3 mm.

In FIG. 2A to FIG. 2C, the horizontal axis is the angle θ. The vertical axis of FIG. 2A is the array factor AF. The vertical axis of FIG. 2B is an element factor EF_{TR} of the transmission and reception. The vertical axis of FIG. 2C is the directivity D_{TR} of the transmission and reception. FIG. 2A corresponds to the characteristics when a deflection angle θ₀ is 20 degrees. The deflection angle θ₀ is an angle referenced to the Z-axis direction.

The array factor AF_{T} of the transmitting element array, the array factor AF_{R} of the receiving element array, and the array factor AF_{TR} of the transmission/reception array are shown in FIG. 2A. The array factor AF_{TR} of the transmission/reception array is the product of the array factor AF_{T} of the transmitting element array and the array factor AF_{R} of the receiving element array.

The array factor AF_{T} of the transmitting element array corresponds to “p_{T}/λ=2”. The array factor AF_{R} of the receiving element array corresponds to “p_{R}/λ=3”.

In the example as shown in FIG. 2A, a peak exists when the angle θ is the deflection angle θ₀ of 20°. The peak corresponds to a main lobe ML. There are other peaks when the angle θ is angles other than 20°. The other peaks that have the same height as the main lobe ML correspond to grating lobes GL. The points where the value of the vertical axis is substantially 0 correspond to “Null”.

A −1 order grating lobe GL (the grating lobe GL(−1)) is in the region at the left of the main lobe ML in FIG. 2A. A −2 order grating lobe GL (the grating lobe GL(−2)) is at the left of the grating lobe GL(−1). There are other grating lobes GL as well. A first-order grating lobe GL (the grating lobe GL(+1)) is in the region at the right of the main lobe ML. −1 order, −2 order, . . . , “Null” are in order of decreasing proximity to the main lobe ML in the region at the left of the main lobe ML. +1 order, +2 order, . . . , “Null” are in order of decreasing proximity to the main lobe ML in the region at the right of the main lobe ML. For example, the grating lobes GL are visible as virtual images in an image generated by scanning an ultrasonic beam. Good detection is possible by setting the grating lobes GL substantially not to exist in the field of view.

In the ultrasonic sensor 119, the condition of “p_{T}/λ=2” and the condition of “p_{R}/λ=3” are employed. In such a case, the angles θ of the ±1 order grating lobes GL of the transmitting element array match the angles θ of “Null” of the receiving element array. In such a case, the grating lobe GL of the array factor AF_{TR} of the transmission and reception disappears at the angles θ corresponding to the ±1 order grating lobes GL of the transmitting element array. On the other hand, the grating lobe GL of the array factor AF_{TR} of the transmission and reception does not disappear at the angle θ corresponding to the −2 order grating lobe GL of the transmitting element array. This angle θ is about 40°.

In the example, the element factor EF_{TR} of the transmission and reception such as that shown in FIG. 2B is applied. In such a case, the element factor EF_{TR} of the transmission and reception is small at the angle θ (about −40°) corresponding to the −2 order grating lobe GL of the transmitting element array. The element factor EF_{TR} of the transmission and reception at the angle θ of about 40° is substantially 0.

Accordingly, as shown in FIG. 2C, the directivity D_{TR} of the transmission and reception is low at this angle θ (about −40°). Thus, for the directivity D_{TR} of the transmission and reception, the peak that corresponds to the −2 order grating lobe GL of the transmitting element array substantially does not occur.

The directivity D_{TR} of the transmission and reception when the deflection angle θ₀ is 0° to 30° is shown in FIG. 2C. In the range where the deflection angle θ₀ is 0° to 20°, an unnecessary peak corresponding to a grating lobe GL substantially does not occur. The directivity D_{TR} becomes small when the deflection angle θ₀ exceeds this range. For example, the desired detection is difficult. Thus, when the deflection angle θ₀ is 20° or less, the effects of the grating lobes GL can be suppressed; and the ultrasonic beam can be deflected.

However, in the ultrasonic sensor 119, the angles at which deflection is possible are 40° or less (±20° or less). The range of the angles at which deflection is possible is narrow. Therefore, the field of view is narrow.

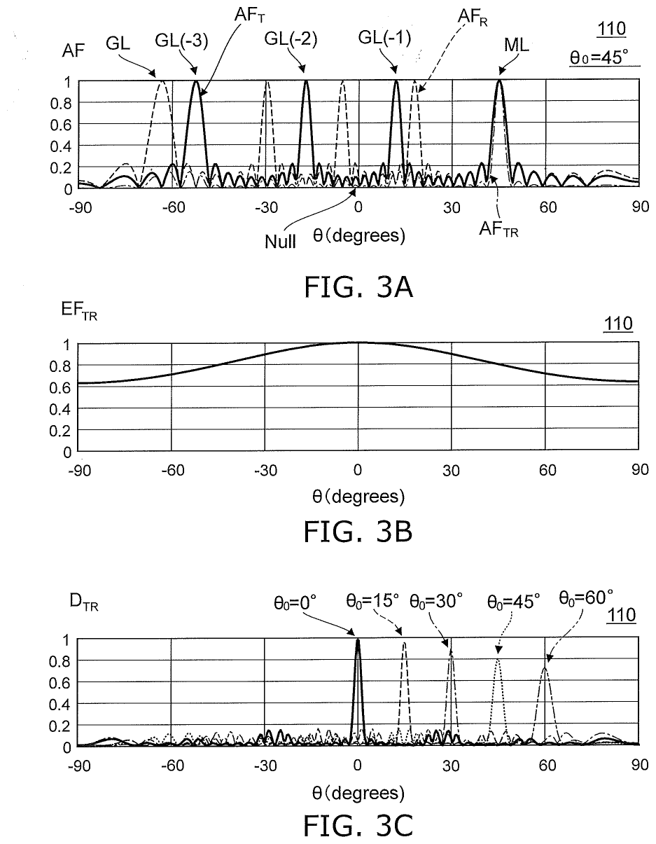

FIG. 3A to FIG. 3C are graphs illustrating characteristics of the ultrasonic sensor according to the embodiment.

These drawings illustrate characteristics of the ultrasonic sensor 110 according to the embodiment. In the ultrasonic sensor 110, the number N_{T} is 10; the number N_{R} is 8; the pitch p_{T} is 2λ; and the pitch p_{R} is 2.5λ. λ is the wavelength of the ultrasonic wave. An element pitch ratio (=p_{R}/p_{T}) is 5/4. The diameters ϕ of the transmitting elements and the receiving elements are 0.6λ. The frequency f of the ultrasonic wave is 40 kHz. In such a case, the wavelength λ is about 8.3 mm.

In FIG. 3A to FIG. 3C, the horizontal axis is the angle θ. The vertical axis of FIG. 3A is the array factor AF. The vertical axis of FIG. 3B is the element factor EF_{TR} of the transmission and reception. The vertical axis of FIG. 3C is the directivity D_{TR} of the transmission and reception. The characteristics of FIG. 3A correspond to the characteristics when the deflection angle θ₀ is 45 degrees.

The array factor AF_{T} of the transmitting element array, the array factor AF_{R} of the receiving element array, and the array factor AF_{TR} of the transmission and reception are shown in FIG. 3A. As shown in FIG. 3A, a −1 order grating lobe GL, a −2 order grating lobe GL, and a −3 order grating lobe GL occur for the array factor AF_{T} of the transmitting element array. The angles θ where these grating lobes GL occur substantially match the angles θ where “Null” of the array factor AF_{R} of the receiving element array occurs. Therefore, the grating lobes GL are suppressed for the array factor AF_{TR} of the transmission and reception. The high-order grating lobes GL can be suppressed.

In such a case, as shown in FIG. 3B, the element factor EF_{TR} of the transmission and reception can be high at a wide range of angles θ. For example, an ultrasonic transducer that has a wide directivity can be used. For example, a wide directivity is obtained by using an air-coupled ultrasonic transducer using a bending vibration, etc. In the embodiment, for example, the element factor EF_{TR} of the transmission and reception when the deflection angle θ₀ is 45 degrees is not less than ½ of the element factor EF_{TR} of the transmission and reception when the deflection angle θ₀ is 0 degrees. In the embodiment, the element factor EF_{TR} of the transmission and reception when the deflection angle θ₀ is 45 degrees may be not less than 0.7 times (i.e., not less than (½^{1/2}) times) the element factor EF_{TR} of the transmission and reception when the deflection angle θ₀ is 0 degrees.

As shown in FIG. 3C, the effects of the grating lobes GL can be suppressed in the range where the deflection angle θ₀ is 0° to 60°. The ultrasonic beam can be deflected in the wide range of angles of 0° to 60°. Thereby, the object can be detected in a wide angle range. According to the embodiment, an ultrasonic sensor that has a wide detection region can be provided. A wide field of view is obtained.

The characteristics of the propagation of the ultrasonic wave are different between the acoustical near-field proximal to the element array and the acoustical far-field distal to the element array. For example, the characteristics described above hold in an acoustical far-field. It is difficult to obtain the desired characteristics in an acoustical near-field. A distance Zb between the element array and the boundary between the acoustical near-field and the acoustical far-field is represented roughly by

Zb=W²/4λ (5).

W is the aperture diameter of the element array. In the embodiment as described below, the aperture diameter W of the element array may be changed substantially. The distance Zb from the element array can be changed thereby. By changing the distance Zb, the object can be detected in a wider range.

An example of the suppression of the effects of the grating lobes GL will now be described.

In the ultrasonic sensor 110 according to the embodiment as described above, the following Formula (1) and Formula (2) are satisfied.

p_{R}/p_{T}=(N_{R}+j)/N_{R} (1)

j≠n·N_{R}/m (2)

In such a case, the effects of the high-order grating lobes GL can be suppressed.

Such characteristics will now be described.

The array factor AF of an element array having the element number N and the pitch p is given by

$$A F ( θ ) = \frac{sin [ \frac{N π p}{λ} ( sin θ - sin {θ}_{0} ) ]}{sin [ \frac{π p}{λ} ( sin θ - sin {θ}_{0} ) ]} . \qquad ( 6 )$$

An angle θₘ where a m-order grating lobe GL (m being an integer) occurs is given by

θₘ=sin⁻¹(sin θ₀+mλ·p) (7),

where m=±1, ±2, ±3, . . . .

The angle θₘ where an n-order “Null” occurs is given by

θₙ=sin⁻¹(sin θ₀+(n/N)·λ/p) (8),

where n=±1, ±2, ±3, . . . , and n≠±N, ±2N, ±3N, . . . .

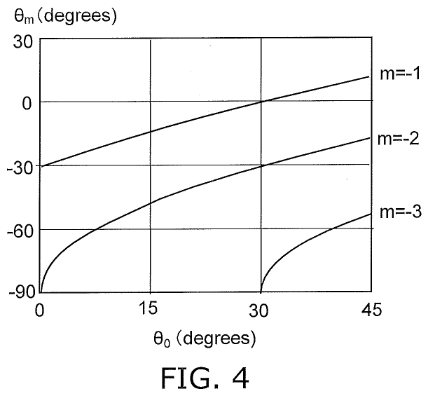

FIG. 4 is a graph illustrating characteristics of the ultrasonic sensor.

FIG. 4 shows characteristics obtained from Formula (7) recited above. In FIG. 4, the horizontal axis is the deflection angle θ₀. The vertical axis is the angle θₘ. FIG. 4 illustrates the angle Gm where the grating lobe GL occurs when p/λ is 2.

In the example as shown in FIG. 4, −1 order, −2 order, and −3 order grating lobes GL occur when the deflection angle θ₀ is 0° to 45°. In the example, it is possible to detect deflection angles θ₀ of ±45° if the grating lobes GL up to the −3 order grating lobe GL can be suppressed.

The following can be derived from Formula (7) and Formula (8) recited above.

For a first condition recited below, the angle θ of the first-order grating lobe GL and the angle θ of “Null” match each other. As the first condition, p/p_{T}≠1, 2, 3, . . . ; n=±N_{R}(p_{R}/p_{T}); and n is an integer.

For a second condition recited below, the angle θ of the second-order grating lobe GL and the angle θ of “Null” match each other. As the second condition, p_{R}/p_{T}≠1/2, 2/2, 3/2, . . . ; n=±N_{R}(2p_{R}/p_{T}); and n is an integer.

For a third condition, the angle θ of the third-order grating lobe GL and the angle θ of “Null” match each other. As the third condition, p_{R}/p_{T}≠1/3, 2/3, 3/3, . . . ; n=±N_{R}(3p_{R}/p_{T}); and n is an integer.

When the first to third conditions recited above are satisfied simultaneously, the first to third-order grating lobes GL can be suppressed simultaneously. For example, in the example shown in FIG. 3A to FIG. 3C, p_{R}/p_{T}=5/4; N_{R}=8; and the first to third conditions recited above are satisfied.

For example, a condition for simultaneously suppressing high-order grating lobes GL up to the k-order (k≥2) is

p_{R}/p_{T}=(N_{R}+j)/N_{R}, and

j≠n·N_{R}/m,

where j=1, 2, . . . , N_{R}−1. m is an integer not less than 1 and not more than k. n is an integer not less than 1 and not more than m−1. Practically, it is sufficient to simultaneously suppress the high-order grating lobes GL up to the sixth-order. Accordingly, it is sufficient for k to be an integer not less than 2 and not more than 6.

These formulas correspond to Formula (1) and Formula (2) described above. In such a case, the high-order grating lobes GL up to the first to k-order can be suppressed simultaneously. Thereby, an appropriate detection can be performed in a wide range of deflection angles θ₀. An ultrasonic sensor that has a wide detection region can be provided.

In the ultrasonic sensor 119 illustrated in FIG. 2A to FIG. 2C, k is 1; and Formula (1) and Formula (2) recited above are not satisfied.

In the embodiment, the deflection angle θ₀ is, for example, not less than −45° and not more than +45°. An aperture diameter W_{T} of the first element array 11A is (N_{T}−1)·p_{T}. An aperture diameter W_{R} of the second element array 12A is (N_{R}−1)·p_{R}. Practically, it is favorable for the aperture diameter W_{T} to be near the aperture diameter W_{R}. Thereby, the ultrasonic sensor is compact. Practically, it is favorable for the number N_{T} to be 16 or less and for the number N_{R} to be 16 or less. If the numbers are excessively high, the ultrasonic sensor becomes large, and the circuit configuration becomes complex. It is favorable for p_{T}/λ to be not less than 1 and not more than 4. It is favorable for p_{R}/p_{T} to be greater than 1 and less than 2. An ultrasonic sensor that has a practical size is obtained easily.

For such practical conditions, examples will now be described for conditions at which the high-order grating lobes GL can be suppressed.

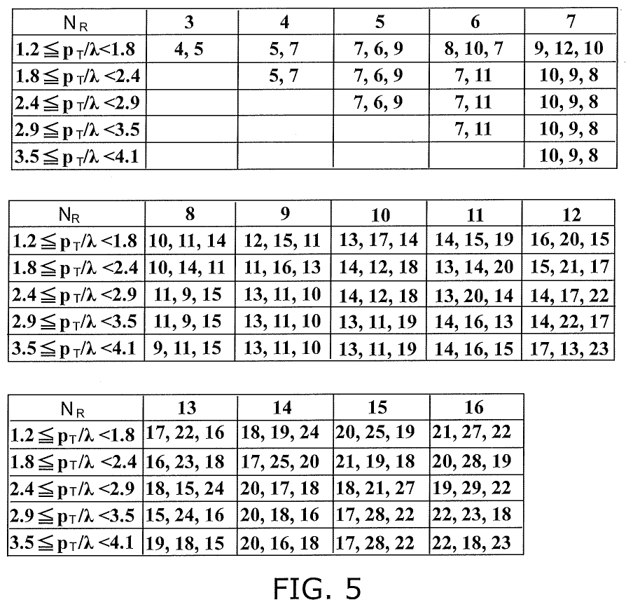

FIG. 5 illustrates characteristics of the ultrasonic sensor.

FIG. 5 illustrates the number (N_{R}+j) at which the high-order grating lobes GL can be suppressed when the number N_{R} is 3 to 16. In FIG. 5, “1.2 p_{T}/λ<1.8” corresponds to the suppression of the first and second-order grating lobes GL. “1.8≤p_{T}/λ<2.4” corresponds to the suppression of the first to third-order grating lobes GL. “2.4≤p_{T}/λ<2.9” corresponds to the suppression of the first to fourth-order grating lobes GL. “2.9≤p_{T}/λ<3.5” corresponds to the suppression of the first to fifth-order grating lobes GL. “3.5≤p_{T}/λ<4.1” corresponds to the suppression of the first to sixth-order grating lobes GL. Practically, it is considered to be sufficient to suppress the first to sixth-order grating lobes GL. The top three values of the number (N_{R}+j) having the highest suppression effect of the grating lobes GL are recited in FIG. 5. For one condition, the values are shown in order of decreasing suppression effect of the grating lobes GL from the left to the right. The suppression effect of the value at the left is higher than the suppression effect at the right.

As shown in FIG. 5, for example, it is favorable for the number (N_{R}+j) to be 4 or 5 when the number N_{R} is 3. For example, it is favorable for the number (N_{R}+j) to be 10, 9, or 8 when the number N_{R} is 7. The first to sixth-order grating lobes GL can be suppressed in such a case. For example, it is favorable for the number (N_{R}+j) to be 22, 18, or 23 when the number N_{R} is 16. The first to sixth-order grating lobes GL can be suppressed in such a case.

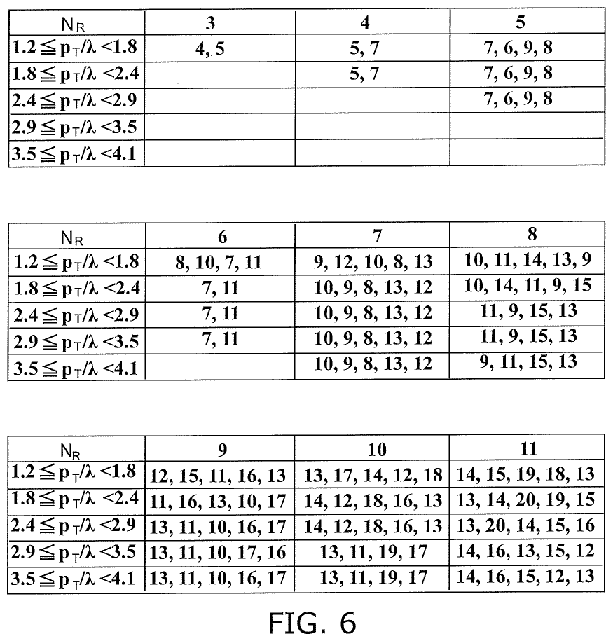

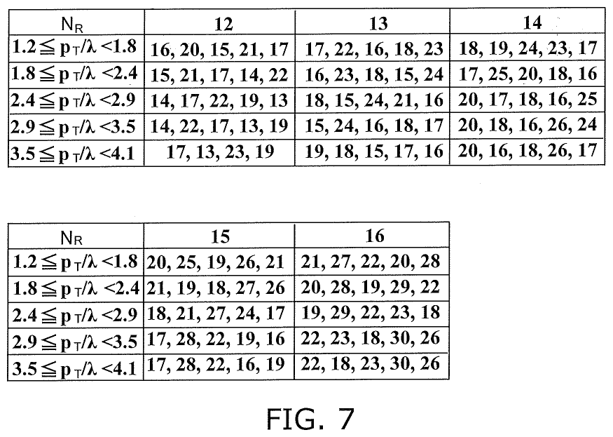

FIG. 6 and FIG. 7 illustrate characteristics of the ultrasonic sensor.

FIG. 6 illustrates the number (N_{R}+j) at which the high-order grating lobes GL can be suppressed when the number N_{R} is 3 to 11. FIG. 7 illustrates the number (N_{R}+j) at which the high-order grating lobes GL can be suppressed when the number N_{R} is 12 to 16. In FIG. 6 and FIG. 7, the top five values of the number (N_{R}+j) having a high suppression effect of the grating lobes GL are recited. For one condition, the values are shown in order of decreasing suppression effect of the grating lobes GL from the left to the right.

As shown in FIG. 7, for example, it is favorable for the number (N_{R}+j) to be 22, 18, 23, 30, or 26 when the number N_{R} is 16. The first to sixth-order grating lobes GL can be suppressed in such a case.

The ultrasonic sensor 110 according to the embodiment is, for example, a phased array. In a phased array, for example, different delays are provided to the transmission voltages supplied to the multiple transmitting elements. By controlling the delay time, the orientation of the ultrasonic beam sent from the element array can be controlled electronically. When receiving, the adding is performed while providing different delays to the reception voltages received by the multiple receiving elements. By controlling the delay times, the ultrasonic wave that arrives at the element array from a designated direction can be enhanced.

In the phased array, the element pitch is taken as p; and the wavelength of the ultrasonic wave is taken as A. In a general phased array, p≤λ/2 is set to suppress the occurrence of the grating lobes GL. On the other hand, a high resolution is obtained by setting the aperture diameter W of the element array to be large. Therefore, due to the constraints of maintaining a small pitch p, the number of the multiple elements is increased to obtain a high resolution.

Conversely, in the embodiment as recited above, the effects of the grating lobes GL are suppressed. In the embodiment, for example, the effects of the grating lobes GL can be suppressed even when the element pitch p is greater than λ/2. Therefore, the aperture diameter W can be large even when the number of elements is small. A high resolution is obtained easily thereby.

For example, in the embodiment, the first pitch p_{T} is greater than ½ of the wavelength of the first ultrasonic wave. For example, the second pitch p_{R} is greater than ½ of the wavelength of the first ultrasonic wave. Because a large pitch can be employed, a large aperture diameter W is obtained using a small number of elements. A high resolution is obtained easily.

In the embodiment, the number N_{R} and the number (N_{R}+j) may include any combination illustrated in FIG. 5 to FIG. 7.

### Second Embodiment

In the second embodiment, the number N_{R} and the number (N_{R}+j) have a common divisor α (α being an integer of 2 or more). The number N_{R} is the product of the common divisor α and β. In the first operation recited above, the processing is performed based on a signal obtained from the N_{R} second elements 12. On the other hand, in a second operation, the processing is performed based on a signal obtained from β second elements 12. For example, this processing also is performed by the processor 70. The β second elements 12 are arranged at the second pitch p_{R}.

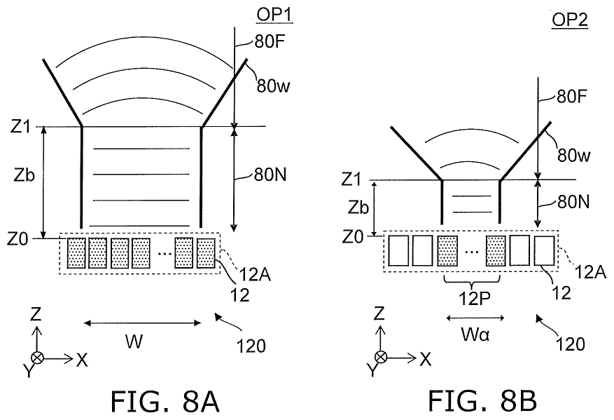

FIG. 8A and FIG. 8B are schematic views illustrating characteristics of the ultrasonic sensor according to the second embodiment.

The ultrasonic sensor 120 according to the second embodiment shown in FIG. 8A and FIG. 8B may have a configuration similar to that of the ultrasonic sensor 110 described in reference to FIG. 1. The ultrasonic sensor 120 performs the first operation or the second operation while changing the number of the second elements 12 used. FIG. 8A corresponds to a first operation OP1. FIG. 8B corresponds to a second operation OP2.

As shown in FIG. 8A, the position in the Z-axis direction of the output end of the second element array 12A is taken as a reference position Z0. An ultrasonic wave 80W propagates in a plane wave configuration in an acoustical near-field 80N proximal to the reference position Z0. In an acoustical far-field 80F distal to the reference position Z0, the ultrasonic wave 80W propagates in a spherical wave configuration. The distance between the reference position Z0 and a boundary Z1 between the acoustical near-field 80N and the acoustical far-field 80F is taken as Zb. As described above, the distance Zb is given by

Zb=W²/4λ (5).

“W” is the aperture diameter of the second element array 12A (referring to FIG. 8A).

For example, the characteristics described in reference to the first embodiment hold for the acoustical far-field 80F. It is difficult to obtain the desired characteristics in the acoustical near-field 80N. For example, when the aperture diameter W of the second element array 12A is large, the distance Zb lengthens; and it is difficult to detect in a region proximal to the ultrasonic sensor 120.

In such a case, in the second operation OP2 as shown in FIG. 8B, the reflected wave is detected by second elements 12P which are a portion of the elements included in the second element array 12A. In such a case, the aperture diameter of the second element array 12A is reduced from the aperture diameter W to an aperture diameter W/α. Thereby, the distance Zb in the second operation OP2 is shorter than that of the first operation OP1. The detection is easy in a region proximal to the ultrasonic sensor 120. The detection range is enlarged.

For example, a proximal region and a distal region can be detected by the first operation OP1 and the second operation OP2. Both a proximal region and a distal region can be viewed.

For example, in the first operation OP1 of FIG. 8A, the number N_{R} is 12, and p_{R}/p_{T}=16/12. The grating lobes GL are suppressed at this condition. In such a case, the common divisor α is 2. In the second operation OP2 of FIG. 8B, N_{R} is 6, and p_{R}/p_{T}=8/6. At this condition as well, the grating lobes GL are suppressed.

The distal region can be detected by twelve second elements 12 included in the second element array 12A. The proximal region can be detected by six second elements 12 included in the second element array 12A. According to the embodiment, the distal region and the proximal region can be viewed while suppressing the grating lobes GL.

For the number N_{T} of the multiple first elements 11, the aperture diameter W_{T} of the first element array 11A is given by (N_{T}−1)·p_{T}. On the other hand, the aperture diameter W_{R} of the second element array 12A is given by (N_{R}−1)·p_{R}. It is sufficient to select the number N_{T} so that the aperture diameter W_{T} is near the aperture diameter W_{R}.

The number N_{R} and the number (N_{R}+j) may have multiple common divisors α. In such a case, the aperture diameter W may be switched between three or more multilevels.

For example, for the acoustical near-field, a second reference example may be considered in which not only the deflection of the ultrasonic beam is performed, but also convergence is performed. In the second reference example, the transmission is performed while changing the convergence position. Therefore, the number of transmission and receptions increases markedly when detecting the proximal region and the distal region. The data acquisition time is long.

Conversely, in the embodiment, the detection region can be changed easily by changing the number of elements used. A wide range can be detected in a short period of time.

Thus, the β second elements 12 are arranged at the second pitch p_{R}. The processor 70 is configured to perform the second operation OP2. In the second operation OP2, the processor 70 causes the multiple first elements 11 to emit a second ultrasonic wave. The processor 70 performs a second processing based on a second signal, which corresponds to a second reflected wave of the second ultrasonic wave and is obtained from the β second elements 12 included in the multiple second elements 12. The processor 70 is capable of outputting a second operation signal as the output signal SigO (referring to FIG. 1). The second operation signal includes the result of the second processing.

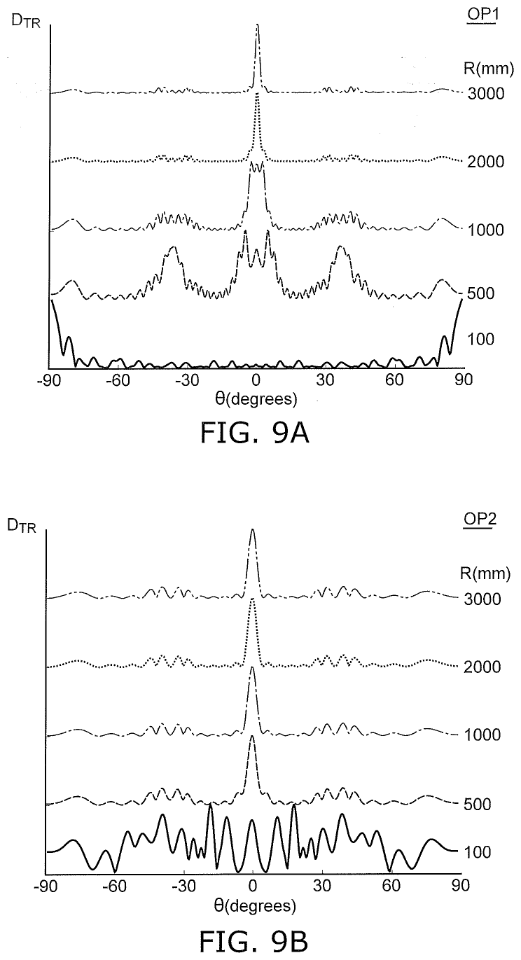

FIG. 9A and FIG. 9B are graphs illustrating characteristics of the ultrasonic sensor according to the second embodiment.

FIG. 9A corresponds to the first operation OP1. FIG. 9B corresponds to the second operation OP2. In FIG. 9A and FIG. 9B, p_{T}/λ is 1.5. p_{R}/p_{T} is 16/12, i.e., 8/6. The frequency f is 40 kHz. In FIG. 9A, the number N_{T} is 16, and the number N_{R} is 12. In such a case, the distance Zb is about 2047 mm. In FIG. 9B, the number N_{T} is 8, and the number N_{R} is 6. In such a case, the distance Zb is about 228 mm. In these figures, the horizontal axis is the angle θ. The vertical axis is the directivity D_{TR} of the transmission and reception. The deflection angle θ₀ is 0°. In the example, the element factor is 1. In these figures, the characteristics are shown for when a distance R between the ultrasonic sensor 120 and the object is 100 mm, 500 mm, 1000 mm, 2000 mm, or 3000 mm.

From these figures, it can be seen that it is sufficient to set the number N_{T} to 8 and the number N_{R} to 6 when 500 mm≤R<2000 mm, and to set the number N_{T} to 16 and the number N_{R} to 12 when 2000 mm≤R.

As shown in FIG. 5, several examples in which the number N_{R} and the number (N_{R}+j) have the common divisor α are as follows. When the number N_{R} is 6, the number (N_{R}+j) is 8 or 10. When the number N_{R} is 8, the number (N_{R}+j) is 10 or 14. When the number N_{R} is 9, the number (N_{R}+j) is 12 or 15. When the number N_{R} is 10, the number (N_{R}+j) is 12, 14, or 18. When the number N_{R} is 12, the number (N_{R}+) is 14, 16, 20, or 22. When the number N_{R} is 14, the number (N_{R}+j) is 16, 18, or 20. When the number N_{R} is 16, the number (N_{R}+j) is 18, 20, 22, or 28.

### Third Embodiment

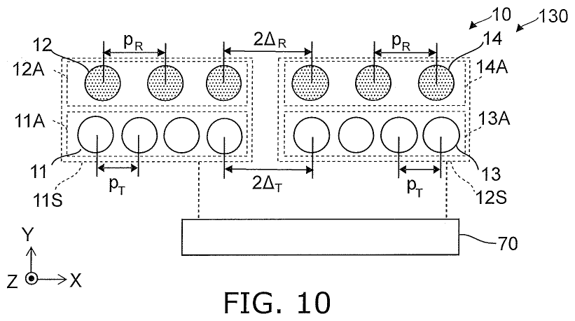

FIG. 10 is a schematic plan view illustrating an ultrasonic sensor according to a third embodiment.

As shown in FIG. 10, the ultrasonic sensor 130 according to the third embodiment includes multiple third elements 13 and multiple fourth elements 14 in addition to the multiple first elements 11 and the multiple second elements 12. The ultrasonic sensor 130 may further include the processor 70. Otherwise, the configuration of the ultrasonic sensor 130 is similar to that of the ultrasonic sensor 110. For example, the processor 70 may have a configuration similar to the configuration described in reference to FIG. 1.

The multiple third elements 13 are included in a third element array 13A. The multiple fourth elements 14 are included in a fourth element array 14A. The third element array 13A and the fourth element array 14A are included in the element part 10.

The multiple third elements 13 are arranged in the first direction (e.g., the X-axis direction) at the first pitch p_{T}. The multiple fourth elements 14 are arranged at the pitch of the multiple fourth elements 14. The first-direction component of the pitch of the multiple fourth elements 14 is the second pitch p_{R}. In the example, the multiple fourth elements 14 are arranged along the first direction (e.g., the X-axis direction) at the second pitch p_{R}.

In the ultrasonic sensor 130, the processor 70 is configured to perform the first operation OP1 recited above. As described above, the detection is performed by the N_{R} second elements 12 in the first operation OP1. The first operation OP1 described in reference to the first embodiment is applicable to the first operation OP1 of the third embodiment.

In the third embodiment, the processor 70 also performs a third operation. The detection is performed by the multiple second elements 12 and the multiple fourth elements 14 in the third operation of the third embodiment.

For example, in the third operation, the processor 70 emits a third ultrasonic wave from the multiple first elements 11 and the multiple third elements 13. The processor 70 performs processing based on a third signal, which corresponds to a third reflected wave of the third ultrasonic wave and is obtained from the N_{R} second elements 12, and based on a fourth signal, which corresponds to the third reflected wave and is obtained from the multiple fourth elements 14.

Thus, the third embodiment switches between the first operation OP1 using the first element array 11A and the second element array 12A and the third operation using the first element array 11A, the second element array 12A, the third element array 13A, and the fourth element array 14A.

For example, the first element array 11A and the second element array 12A are included in a first subarray 11S. The third element array 13A and the fourth element array 14A are included in a second subarray 12S. The second subarray 12S has a configuration similar to that of the first subarray 11S.

For example, the number of the multiple third elements 13 is the same as the number N_{T} of the multiple first elements 11. The number of the multiple fourth elements 14 is the same as the number N_{R} of the multiple second elements 12. The distance along the first direction between the first-direction center of the first element 11 most proximal to the multiple third elements 13 among the multiple first elements 11 and the first-direction center of the third element 13 most proximal to the multiple first elements 11 among the multiple third elements 13 is 2Δ_{T}. 2Δ_{T} is different from the first pitch p_{T}. The distance along the first direction between the first-direction center of the second element 12 most proximal to the multiple fourth elements 14 among the multiple second elements 12 and the first-direction center of the fourth element 14 most proximal to the multiple second elements 12 among the multiple fourth elements 14 is 2Δ_{R}. 2Δ_{R} is different from the second pitch p_{R}.

When the first element array 11A and the third element array 13A operate simultaneously, the array factor AF_{T}(θ) of the transmitting element is given by

$${AF}_{T} ( θ ) = 2 cos \{ \frac{π [ ( {N}_{T} - 1 ) {p}_{T} + 2 {Δ}_{T} ]}{λ} ( sin θ - sin {θ}_{0} ) \} \times \frac{1}{{N}_{T}} \frac{sin [ \frac{{N}_{T} π {p}_{T}}{λ} ( sin θ - sin {θ}_{0} ) ]}{sin [ \frac{π {p}_{T}}{λ} ( sin θ - sin {θ}_{0} ) ]} . \qquad ( 9 )$$

When the second element array 12A and the fourth element array 14A operate simultaneously, the array factor of the receiving element also is similar to Formula (9).

The second term on the right side of Formula (9) is similar to Formula (6). When the first subarray 11S and the second subarray 12S operate simultaneously as well, the grating lobes GL of the subarray and the positions of the “Nulls” match.

For example, the design is performed to suppress the high-order grating lobes GL in each of the multiple subarrays. Thereby, the high-order grating lobes GL can be suppressed even when the multiple subarrays operate simultaneously.

For example, by using two subarrays in which the high-order grating lobes GL can be suppressed, the first operation OP1 in which one subarray is operated is performed; and the third operation in which two subarrays operate simultaneously is performed. The aperture diameter can be modified thereby. For example, the first operation OP1 is performed when detecting the proximal distance. For example, the third operation is performed when detecting the distal distance. In the embodiment, the number of subarrays may be any integer of 2 or more.

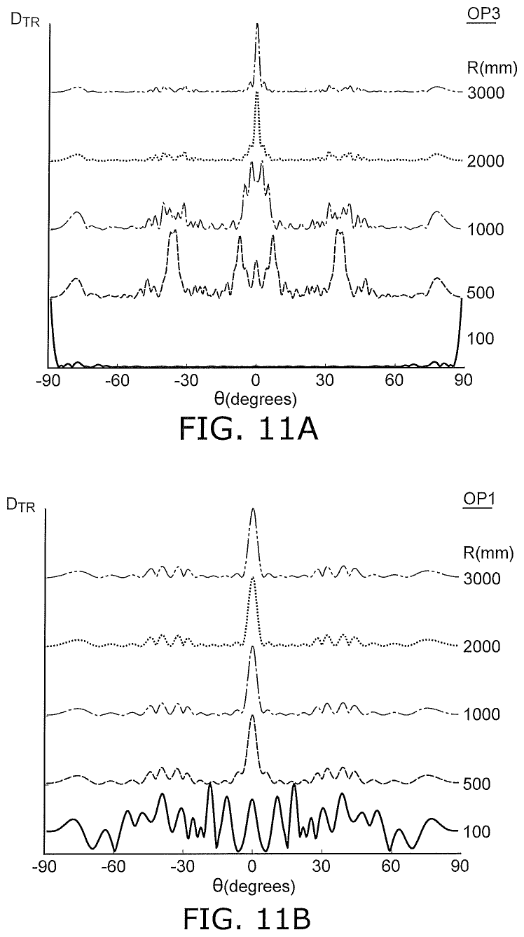

FIG. 11A and FIG. 11B are graphs illustrating characteristics of the ultrasonic sensor according to the third embodiment.

FIG. 11A corresponds to the third operation OP3. FIG. 11B corresponds to the first operation OP1. In FIG. 11A and FIG. 11B, p_{T}/λ is 1.5. p_{R}/p_{T} is 8/6. The number N_{T} is 8. The number N_{R} is 6. The frequency f is 40 kHz. Δ_{T}/λ is 1.8. λ_{R} is 1.7. In FIG. 11A, both the first subarray 11S and the second subarray 12S operate. In such a case, the distance Zb is about 1252 mm. In FIG. 11B, the first subarray 11S operates; but the second subarray 12S does not operate. In such a case, the distance Zb is about 228 mm. In these figures, the horizontal axis is the angle θ. The vertical axis is the directivity D_{TR} of the transmission and reception. The deflection angle θ₀ is 0°. In the example, the element factor is 1. In these figures, the characteristics are shown for when the distance R between the ultrasonic sensor 120 and the object is 100 mm, 500 mm, 1000 mm, 2000 mm, or 3000 mm.

From these figures, it can be seen that it is sufficient to perform the first operation OP1 which operates one of the subarrays when 500 mm≤R<2000 mm, and perform the third operation OP3 which operates both subarrays when 2000 mm≤R.

Thus, in the embodiment, the number of subarrays used may be changed according to the measurement distance.

A combination of the second embodiment and the third embodiment may be performed. For example, in one of the multiple subarrays, the number N_{R} and the number (N_{R}+j) are set to have the common divisor α. For example, the switching between the distal distance and an intermediate distance is performed by, for example, switching the subarrays. For example, the switching between the intermediate distance and the proximal distance is performed by switching the number of elements used.

FIG. 12A and FIG. 12B are schematic cross-sectional views illustrating the ultrasonic sensor according to the embodiment.

FIG. 12A corresponds to the first element array 11A. FIG. 12B corresponds to the second element array 12A.

As shown in FIG. 12A, one of the multiple first elements 11 includes an electrode 11c, an electrode 11d, and an intermediate layer 11i. The intermediate layer 11i is provided between the electrode 11c and the electrode 11d. The intermediate layer 11i includes, for example, a piezoelectric material, etc. The first element 11 is supported by a supporter 31u. The supporter 31u is fixed to a base body 31s. The first element 11 is separated from the base body 31s. A diaphragm that includes the intermediate layer 11i deforms in the Z-axis direction due to a voltage applied between the electrode 11c and the electrode 11d. A sound wave is produced thereby.

As shown in FIG. 12B, one of the multiple second elements 12 includes an electrode 12c, an electrode 12d, and an intermediate layer 12i. The intermediate layer 12i is provided between the electrode 12c and the electrode 12d. The intermediate layer 12i includes, for example, a piezoelectric material, etc. The second element 12 is supported by a supporter 32u. The supporter 32u is fixed to a base body 32s. The second element 12 is separated from the base body 32s. A diaphragm that includes the intermediate layer 11i deforms in the Z-axis direction when a sound wave is incident on the second element 12. An electrical signal is generated between the electrode 12c and the electrode 12d based on the deformation. This signal corresponds to the detection signal.

FIG. 13 is a schematic view showing a usage example of the ultrasonic sensor according to the embodiment.

As shown in FIG. 13, for example, the ultrasonic sensor 110 can detect slack in a tape 520. For example, the tape 520 is fed by a roller 521. There are cases where slack occurs in the tape 520 due to a tensile force applied to the tape 520, the state of the roller 521, etc. By using the ultrasonic sensor 110 according to the embodiment, the distribution of the slack can be detected by using the deflection of an ultrasonic beam. Compared to a reference example in which one ultrasonic sensor detects the slack at one point, the state of the slack of the tape 520 can be detected stably. In the case where the detection is performed using light, the detection accuracy is low if the tape 520 is transparent. By detecting using the ultrasonic wave, a transparent tape 520 can be detected with high accuracy. The constraints of the detection object are relaxed by detecting using the ultrasonic wave.

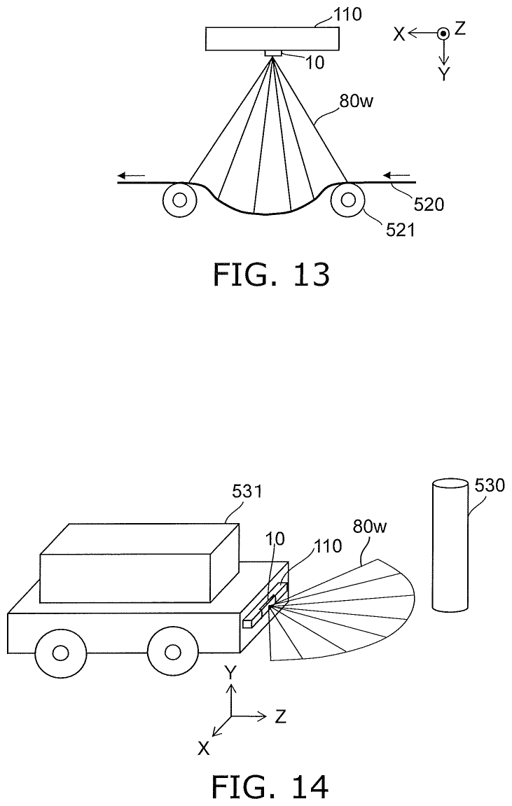

FIG. 14 is a schematic view showing a usage example of the ultrasonic sensor according to the embodiment.

As shown in FIG. 14, for example, the ultrasonic sensor 110 may be provided in an autonomous mobile robot 531. For example, an obstacle 530 that is on the path of the autonomous mobile robot 531 is detected by the ultrasonic sensor 110. In the embodiment, the detection is possible at a large deflection angle θ₀. Thereby, the distance and the direction of the obstacle 530 can be detected in a wide range. The autonomous mobile robot 531 easily can advance while avoiding the obstacle.

In an ultrasonic sensor of a reference example that uses a transmitting element and a receiving element, the deflection angle θ₀ is small, and the field of view is narrow. In the reference example, it is difficult to view a proximal distance. In the embodiment, a large field of view is obtained. In the embodiment, the distal distance and the proximal distance can be viewed easily.

In the embodiment, the acoustic medium is, for example, air. In the embodiment, the acoustic medium may be, for example, any gas, any liquid, or any solid.

For example, the ultrasonic sensor according to the embodiment is used to detect an obstacle in the surroundings. For example, the ultrasonic sensor is used to recognize the configuration of the object. The ultrasonic sensor that uses an ultrasonic wave can detect a transparent object. The ultrasonic sensor is inexpensive and has few limits of use.

The embodiments include the following configurations (e.g., technological proposals).

### Configuration 1

An ultrasonic sensor, comprising:

a plurality of first elements; and

a plurality of second elements,

the plurality of first elements emitting a first ultrasonic wave,

a first operation being performed, the first operation including processing based on a first signal, the first signal corresponding to a first reflected wave of the first ultrasonic wave and being obtained from N_{R} of the second elements (N_{R} being an integer of 3 or more) included in the plurality of second elements,

the plurality of first elements being arranged in a first direction at a first pitch p_{T}, the first pitch p_{T} being in the first direction,

the N_{R} second elements being arranged at a pitch of the plurality of second elements, a component in the first direction of the pitch of the plurality of second elements being a second pitch p_{R},

p_{R}/p_{T} being not less than 0.97 times and not more than 1.03 times (N_{R}+j)/N_{R}, j not being n·N_{R}/m, m being an integer not less than 1 and not more than k, n being an integer not less than 1 and not more than (m−1), j being an integer not less than 1 and not more than (N_{R}−1), k being an integer not less than 2 and not more than 6.

### Configuration 2

An ultrasonic sensor, comprising:

a plurality of first elements; and

a plurality of second elements,

the plurality of first elements emitting a first ultrasonic wave,

a first operation being performed, the first operation including processing based on a first signal, the first signal corresponding to a first reflected wave of the first ultrasonic wave and being obtained from N_{R} of the second elements (N_{R} being an integer of 3 or more) included in the plurality of second elements,

the plurality of first elements being arranged in a first direction at a first pitch p_{T}, the first pitch p_{T} being in the first direction,

the N_{R} second elements being arranged at a pitch of the plurality of second elements, a component in the first direction of the pitch of the plurality of second elements being a second pitch p_{R},

N_{R}, the first pitch p_{T}, and the second pitch p_{R} satisfying

p_{R}/p_{T}=(N_{R}+1)/N_{R} (1), and

j≠n·N_{R}/m (2),

m being an integer not less than 1 and not more than k,

n being an integer not less than 1 and not more than (m− 1),

j being an integer not less than 1 and not more than (N_{R}−1),

k being an integer not less than 2 and not more than 6.

### Configuration 3

The ultrasonic sensor according to Configuration 1 or 2, further comprising a processor,

in the first operation, the processor causing the first ultrasonic wave to be emitted from the plurality of first elements,

in the first operation, the processor being capable of acquiring the first signal and outputting a first operation signal, the first operation signal including a result of the processing based on the first signal.

### Configuration 4

The ultrasonic sensor according to Configuration 3, wherein

N_{R} and (N_{R}+j) have a common divisor α (α being an integer of 2 or more),

N_{R} is a product of the common divisor α and β,

the processor also is configured to perform a second operation,

in the second operation, the processor causes the plurality of first elements to emit a second ultrasonic wave, and

the processor performs a second processing based on a second signal, the second signal corresponding to a second reflected wave of the second ultrasonic wave and being obtained from β of the second elements included in the plurality of second elements.

### Configuration 5

The ultrasonic sensor according to Configuration 3 or 4, further comprising:

a plurality of third elements; and

a plurality of fourth elements,

the plurality of third elements being arranged in the first direction at the first pitch p_{T},

the plurality of fourth elements being arranged at a pitch of the plurality of fourth elements, a component in the first direction of the pitch of the plurality of fourth elements being the second pitch p_{R},

the processor also performing a third operation,

in the third operation, the processor causing a third ultrasonic wave to be emitted from the plurality of first elements and the plurality of third elements,

the processor performing processing based on a third signal and a fourth signal, the third signal corresponding to a third reflected wave of the third ultrasonic wave and being obtained from the N_{R} second elements, the fourth signal corresponding to the third reflected wave and being obtained from the plurality of fourth elements.

### Configuration 6

The ultrasonic sensor according to any one of Configurations 1 to 5, wherein the second pitch p_{R} is greater than ½ of a wavelength of the first ultrasonic wave.

### Configuration 7

The ultrasonic sensor according to any one of Configurations 1 to 5, wherein the first pitch p_{T} is greater than ½ of a wavelength of the first ultrasonic wave.

### Configuration 8

The ultrasonic sensor according to any one of Configurations 1 to 7, wherein

N_{R} is 6, and

(N_{R}+j) is 8 or 10.

### Configuration 9

The ultrasonic sensor according to any one of Configurations 1 to 7, wherein

N_{R} is 8, and

(N_{R}+j) is 10 or 14.

### Configuration 10

The ultrasonic sensor according to any one of Configurations 1 to 7, wherein

N_{R} is 9, and

(N_{R}+j) is 12 or 15.

### Configuration 11

The ultrasonic sensor according to any one of Configurations 1 to 7, wherein

N_{R} is 10, and

(N_{R}+j) is 12, 14, or 18.

### Configuration 12

The ultrasonic sensor according to any one of Configurations 1 to 7, wherein

N_{R} is 12, and

(N_{R}+j) is 14, 16, 20, or 22.

### Configuration 13

The ultrasonic sensor according to any one of Configurations 1 to 7, wherein

N_{R} is 14, and

(N_{R}+j) is 16, 18, or 20.

### Configuration 14

The ultrasonic sensor according to any one of Configurations 1 to 7, wherein

N_{R} is 16, and

(N_{R}+j) is 18, 20, 22, or 28.

According to the embodiments, an ultrasonic sensor that has a wide detection region can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in ultrasonic sensors such as elements, processors, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all ultrasonic sensors practicable by an appropriate design modification by one skilled in the art based on the ultrasonic sensors described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An ultrasonic sensor, comprising:
a plurality of first elements; and
a plurality of second elements,
the plurality of first elements emitting a first ultrasonic wave,
a first operation being performed, the first operation including processing based on a first signal, the first signal corresponding to a first reflected wave of the first ultrasonic wave and being obtained from N_{R} of the second elements (N_{R} being an integer of 3 or more) included in the plurality of second elements,
the plurality of first elements being arranged in a first direction at a first pitch p_{T}, the first pitch p_{T} being in the first direction,
the N_{R} second elements being arranged at a pitch of the plurality of second elements, a component in the first direction of the pitch of the plurality of second elements being a second pitch p_{R},
p_{R}/p_{T} being not less than 0.97 times and not more than 1.03 times (N_{R}+j)/N_{R}, j not being n·N_{R}/m, m being an integer not less than 1 and not more than k, n being an integer not more than (m−1), j being an integer not less than 1 and not more than (N_{R}−1), k being an integer not less than 2 and not more than 6.

2. An ultrasonic sensor, comprising:
a plurality of first elements; and
a plurality of second elements,
the plurality of first elements emitting a first ultrasonic wave,
a first operation being performed, the first operation including processing based on a first signal, the first signal corresponding to a first reflected wave of the first ultrasonic wave and being obtained from N_{R} of the second elements (N_{R} being an integer of 3 or more) included in the plurality of second elements,
the plurality of first elements being arranged in a first direction at a first pitch p_{T}, the first pitch p_{T} being in the first direction,
the N_{R} second elements being arranged at a pitch of the plurality of second elements, a component in the first direction of the pitch of the plurality of second elements being a second pitch p_{R},
N_{R}, the first pitch p_{T}, and the second pitch p_{R} satisfying
p_{R}/p_{T}=(N_{R}+j)/N_{R} (1), and
j≠n·N_{R}/m (2),
m being an integer not less than 1 and not more than k,
n being an integer not less than 1 and not more than (m− 1),
j being an integer not less than 1 and not more than (N_{R}−1),
k being an integer not less than 2 and not more than 6.

3. The sensor according to claim 1, further comprising a processor,
in the first operation, the processor causing the first ultrasonic wave to be emitted from the plurality of first elements,
in the first operation, the processor being capable of acquiring the first signal and outputting a first operation signal, the first operation signal including a result of the processing based on the first signal.

4. The sensor according to claim 3, wherein
N_{R} and (N_{R}+j) have a common divisor α (α being an integer of 2 or more),
N_{R} is a product of the common divisor α and β,
the processor also is configured to perform a second operation,
in the second operation, the processor causes the plurality of first elements to emit a second ultrasonic wave, and
the processor performs a second processing based on a second signal, the second signal corresponding to a second reflected wave of the second ultrasonic wave and being obtained from β of the second elements included in the plurality of second elements.

5. The sensor according to claim 3, further comprising:
a plurality of third elements; and
a plurality of fourth elements,
the plurality of third elements being arranged in the first direction at the first pitch p_{T},
the plurality of fourth elements being arranged at a pitch of the plurality of fourth elements, a component in the first direction of the pitch of the plurality of fourth elements being the second pitch p_{R},
the processor also performing a third operation,
in the third operation, the processor causing a third ultrasonic wave to be emitted from the plurality of first elements and the plurality of third elements,
the processor performing processing based on a third signal and a fourth signal, the third signal corresponding to a third reflected wave of the third ultrasonic wave and being obtained from the N_{R} second elements, the fourth signal corresponding to the third reflected wave and being obtained from the plurality of fourth elements.

6. The sensor according to claim 1, wherein the second pitch p_{R} is greater than ½ of a wavelength of the first ultrasonic wave.

7. The sensor according to claim 1, wherein the first pitch p_{T} is greater than ½ of a wavelength of the first ultrasonic wave.

8. The sensor according to claim 1, wherein
N_{R} is 6, and
(N_{R}+j) is 8 or 10.

9. The sensor according to claim 1, wherein
N_{R} is 8, and
(N_{R}+j) is 10 or 14.

10. The sensor according to claim 1, wherein
N_{R} is 9, and
(N_{R}+j) is 12 or 15.

11. The sensor according to claim 1, wherein
N_{R} is 10, and
(N_{R}+j) is 12, 14, or 18.

12. The sensor according to claim 1, wherein
N_{R} is 12, and
(N_{R}+j) is 14, 16, 20, or 22.

13. The sensor according to claim 1, wherein
N_{R} is 14, and
(N_{R}+j) is 16, 18, or 20.

14. The sensor according to claim 1, wherein
N_{R} is 16, and
(N_{R}+j) is 18, 20, 22, or 28.
